(19) United States
(12) Patent Application Publication
(10) Pub. No.: US 2017/0086128 A1
(43) Pub. Date: Mar. 23, 2017

(54) OPTIMIZING CELL SCANNING AND CELL SELECTION BASED ON ROUTE OF TRAVEL

(71) Applicant: QUALCOMM Incorporated, San Diego, CA (US)

(72) Inventors: Sai Pradeep Venkatraman, Santa Clara, CA (US); Weihua Gao, San Jose, CA (US); Benjamin Werner, Sunnyvale, CA (US)

(21) Appl. No.: 14/862,685

(22) Filed: Sep. 23, 2015

(51) Int. Cl. H04W 48/04; H04W 48/16; H04W 48/20

(52) U.S. Cl. CPC H04W 48/04; H04W 48/20; H04W 48/16

(57) ABSTRACT

Techniques are disclosed for streamlining and/or optimizing how a mobile device in a telecommunications network conducts scans for candidate cells with which to communicate data. The techniques utilize route data taken from a navigation application to determine a route along which the mobile device will travel and cell coverage information to identify cells along the determined route. Based on the route information and cell coverage information, the mobile device can optimize cell scanning and/or cell selection along the route of travel.

### BACKGROUND

A mobile device, such as a mobile phone, performs certain steps before it can receive or transmit data in a telecommunication network utilizing long-term evolution (LTE) and/or other technologies. Included in these steps is the selection of a nearby cell with which to establish a communication link. During this cell selection process, the mobile device scans all radio frequency (RF) channels in the applicable RF band to detect candidate cells. From these candidate cells, the mobile device will then select a suitable cell, which is typically the cell with the strongest signal.

Traditional scans can be relatively lengthy in an effort to ensure that many candidate cells are detected. However, the scanning process requires a large amount of power, which can reduce the battery life of the mobile device.

### SUMMARY

The various aspects of implementations described herein utilize techniques that streamline and/or optimize the scanning process using predictive data assistance based on route of travel. In particular, the techniques utilize route data taken from a navigation application executed by the mobile device to determine a predicted route along which the mobile device will travel. By using known cell coverage information, cells along the determined route can be identified. The mobile device can then conduct more efficient scans by stopping scans once the identified cells have been detected.

An example method for optimizing cell scanning at a mobile device, according to the disclosure, comprises obtaining information regarding a planned route of travel of the mobile device, obtaining coverage information regarding a plurality of cells, the coverage information indicative of a geographical coverage area for each cell of the plurality of cells, and identifying, using the coverage information regarding the plurality of cells, a subset of the plurality of cells, based on the planned route of travel.

The example method can further comprise one or more of the following features. Obtaining the information regarding the planned route of travel, obtaining the coverage information regarding the plurality of cells, and identifying the subset of the plurality of cells may be performed, at least in part, by a server, and sending, from the server, the information indicative of the identified subset to the mobile device. The information indicative of the identified subset can comprise information indicative of a plurality of tiles representing geographical areas along the planned route of travel, and for each tile of the plurality of tiles, one or more cells corresponding to the tile. The method may further comprise defining, subsequent to obtaining the information regarding the planned route of travel, one or more tiles of the plurality of tiles. The method may further comprise determining a speed of the mobile device, where a size of at least one tile of the plurality of tiles is based on the determined speed of the mobile device. Identifying the subset of the plurality of cells may be performed by the mobile device, and obtaining coverage information regarding the plurality of cells may comprise receiving, with the mobile device, the information regarding the plurality of cells from a server. The method may further comprise selecting candidate cells for scanning, based on the identified subset of the plurality of cells. The method may further comprise ending a scan after one or more signals from each of the candidate cells has been detected by the mobile device.

An example mobile device, according to the disclosure, comprises a memory, a communication interface, and a processing unit communicatively coupled to the memory and the communication interface. The processing unit is configured to cause the mobile device to obtain information regarding a planned route of travel of the mobile device, and obtain coverage information regarding a plurality of cells, the coverage information indicative of a geographical coverage area for each cell of the plurality of cells. The processing unit is further configured to cause the server to identify, using the coverage information regarding the plurality of cells, a subset of the plurality of cells, based on the planned route of travel.

The example mobile device can comprise one or more of the following features. The processing unit may be configured to cause the mobile device to obtain information regarding the plurality of cells by obtaining information indicative of a plurality of tiles representing geographical areas along the planned route of travel, where for each tile of the plurality of tiles, one or more cells corresponds to the tile. The processing unit may be further configured to cause the mobile device to cause the mobile device to obtain the coverage information regarding the plurality of cells by sending the information regarding the planned route of travel of the mobile device to a server; and receiving the coverage information regarding the plurality of cells from the server. The processing unit may be further configured to cause the mobile device to select candidate cells for scanning based on the identified subset of the plurality of cells.

An example apparatus, according to the disclosure, comprises means for obtaining information regarding a planned route of travel of the mobile device, and means for obtaining coverage information regarding a plurality of cells, the coverage information indicative of a geographical coverage area for each cell of the plurality of cells. The example apparatus further includes means for identifying, using the coverage information regarding the plurality of cells, a subset of the plurality of cells, based on the planned route of travel.

The example apparatus can comprise one or more of the following features. The apparatus may comprise a server further comprising means for sending, from the server, the information indicative of the identified subset to the mobile device. The means for sending the information indicative of the identified subset may comprise means for providing information indicative of a plurality of tiles representing geographical areas along the planned route of travel, and for each tile of the plurality of tiles, one or more cells corresponding to the tile. The apparatus may further comprise means for defining, subsequent to obtaining the information regarding the planned route of travel, one or more tiles of the plurality of tiles. The apparatus may further comprise means for determining a speed of the mobile device, wherein a size of at least one tile of the plurality of tiles is based on the determined speed of the mobile device. The apparatus may comprise a mobile device, where the means for obtaining coverage information regarding the plurality of cells comprises means for receiving, with the mobile device, the information regarding the plurality of cells from a server. The apparatus may further comprise means for selecting candidate cells for scanning based on the identified subset of the plurality of cells. The apparatus may further comprise means for ending a scan after one or more signals from each of the candidate cells has been detected by the mobile device.

### BRIEF DESCRIPTION OF THE DRAWINGS

An understanding of the nature and advantages of various embodiments may be realized by reference to the following figures.

FIG. 1 is a simplified illustration of a telecommunication system capable of implementing techniques for providing predictive data assistance, according to one embodiment.

FIG. 2 is an example illustration of a map, used to help visualize a route of travel from a point of origin to a destination.

FIG. 3 is an example illustration of how relevant cells are identified on the map of FIG. 2.

FIG. 4 is an example illustration of how information can be represented using a plurality of tiles.

FIGS. 5A and 5B are call flow diagrams that help illustrate the interaction between a mobile device and a server, according to different embodiments.

FIG. 6 is a flow diagram illustrating a method for enabling predictive data assistance at a mobile device, according to one embodiment.

FIG. 7 is block diagram of a mobile device, according to one embodiment.

FIG. 8 is block diagram of a computer system, according to one embodiment.

### DETAILED DESCRIPTION

The ensuing description provides embodiment(s) only, and is not intended to limit the scope, applicability or configuration of the disclosure. Rather, the ensuing description of the embodiment(s) will provide those skilled in the art with an enabling description for implementing an embodiment. It is understood that various changes may be made in the function and arrangement of elements without departing from the spirit and scope of this disclosure.

A wireless wide area network (WWAN) can utilize mobile telecommunication cellular network technology such as long-term evolution (LTE) to enable electronic devices—such as mobile phones and other mobile devices—to transmit and receive data over a large geographical region, using antennas (e.g., cell towers). In such a network, each antenna can have one or more cell identifiers (cell IDs), each corresponding to a cell that covers a geographical region, to offer a coverage area in which electronic devices can communicate wirelessly with the antenna.

Consumer demand, coverage needs, and other factors can prompt a WWAN provider, such as a cell-phone carrier, to provide multiple antennas in an area, which can result in overlapping cell coverage areas. Thus, for an electronic device at a given location, there may be multiple cells with which the electronic device may establish a communication link. The electronic device can therefore select a suitable cell, from many candidate cells, with which the electronic device can establish a communication link to the WWAN.

For mobile devices that may frequently change location, the selection of a suitable cell can be frequently reoccurring process. In some WWANs, for example, mobile devices can conduct scans approximately every seven seconds to detect various candidate cells with which the mobile device can establish a communication link. A suitable cell is then chosen from the candidate cells, typically based on measured signal strength. As previously indicated, however, these scanning processes, which can include many signal strength calculations, can take a relatively large amount of power, reducing the battery life of a mobile device.

Techniques disclosed herein streamline the scanning process by utilizing route data taken from a navigation application executed by the mobile device to determine a route along which the mobile device will travel. By using known cell coverage information, cells along the determined route can be identified and provided at a mobile device as predictive data assistance, predicting which cells the mobile device will encounter along the determined route of travel. The mobile device can then conduct more efficient scans by stopping the scans once the identified cells have been detected. In so doing, the mobile device can reduce the amount of power used and increase battery life.

It can be noted that although embodiments herein describe the use of cells in the context of a cellular carrier, embodiments are not so limited. Techniques provided herein can utilize other analogous technologies (e.g., WIFI, IBEACON, and the like.) additionally or alternatively.

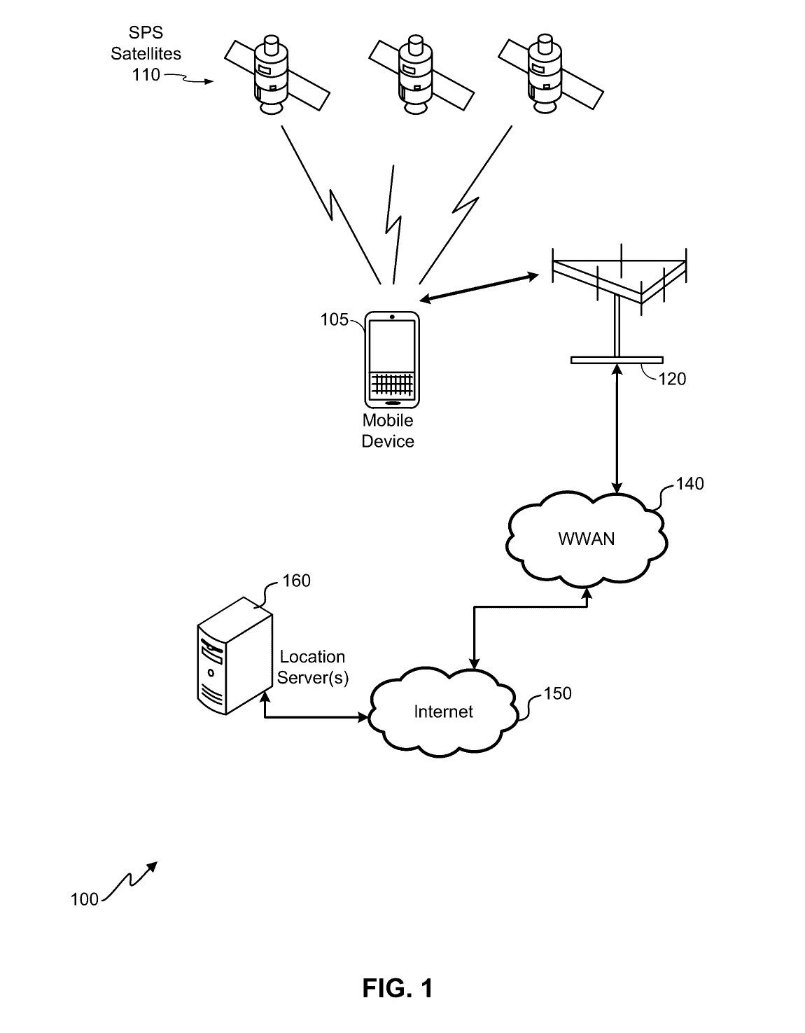

FIG. 1 is a simplified illustration of a telecommunication system 100 capable of implementing these techniques, according to one embodiment. The telecommunication system 100 may comprise at least one mobile device 105, satellite positioning system (SPS) satellites 110, WWAN 140, antenna 120, location server(s) 160, and the Internet 150. It should be noted that FIG. 1 provides only a generalized illustration of various components, any or all of which may be utilized as appropriate, and each of which may be duplicated as necessary. Specifically, although only one mobile device 105 is illustrated, it will be understood that many mobile devices (e.g., hundreds, thousands, millions, etc.) may be utilized in the telecommunication system 100. Similarly, the telecommunication system 100 may include many antennas 120. Furthermore, components may be rearranged, combined, separated, substituted, and/or omitted, depending on desired functionality. A person of ordinary skill in the art will recognize many modifications to the components illustrated.

As previously stated, each antenna 120 of the WWAN 140 may establish one or more cells. (In some embodiments, for example, the antenna may comprise a three-sided directional antenna, resulting in cellular coverage of a circular geographical area split into three pie-shaped cells, each spanning 120 degrees of the circular geographical area.) As the mobile device moves from location to location, it can conduct scans to detect various candidate cells, and select a suitable cell with which to establish a communication link to the WWAN 140.

The telecommunication system 100 may further facilitate positioning and/or navigation functionality of the mobile device. For example, the mobile device 105 may calculate its location using SPS satellites 110, such as the Global Positioning System (GPS) or GLONASS. Additionally or alternatively, the mobile device may execute an application that provides navigational functionality, providing a route of travel by which a user may reach a desired destination. In some embodiments, the navigation program may include a map that illustrates the route of travel. In embodiments where GPS or other positioning functionality is provided to the navigation program, the navigation program may show the mobile device's current position on the map and/or provide real-time audio and/or visual instructions for navigating along the route of travel. As provided in further detail below, such a route of travel can be utilized to help identify cells with which the mobile device may establish a communication link, and increase the efficiency of scans.

The antenna 120 is communicatively coupled with the WWAN 140 (e.g., a cellular network), which may be communicatively coupled with the Internet 150. Because the location server(s) 160 can also be communicatively coupled with the Internet 150, the mobile device 105 and location server(s) 160 can communicate with each other via the Internet. In some embodiment, the mobile device 105 and location server(s) 160 may communicate via means other than the WWAN 140 and/or Internet 150, such as via a local area network (LAN)(not shown) connected to the Internet 150.

Among other things, the location server(s) 160 can gather and store coverage information of the various cells of the WWAN 140. This coverage information can include, for example, the location of antenna(s) 120, coverage area(s) of associated cell(s), and/or other information by which information regarding cell coverage for various locations in the WWAN 140 may be determined The accuracy and/or granularity of the coverage information obtained by the location server(s) 160 can depend on the manner in which the information was obtained. In some embodiments, for example, the coverage information may be obtained from the WWAN provider. In some embodiments, the coverage information may be crowdsourced information from mobile devices within the WWAN 140 by, for example, determining the location of a mobile device 105 (e.g., using GPS and/or other positioning data) and indicating whether the signal strength for a cell is above a certain threshold.

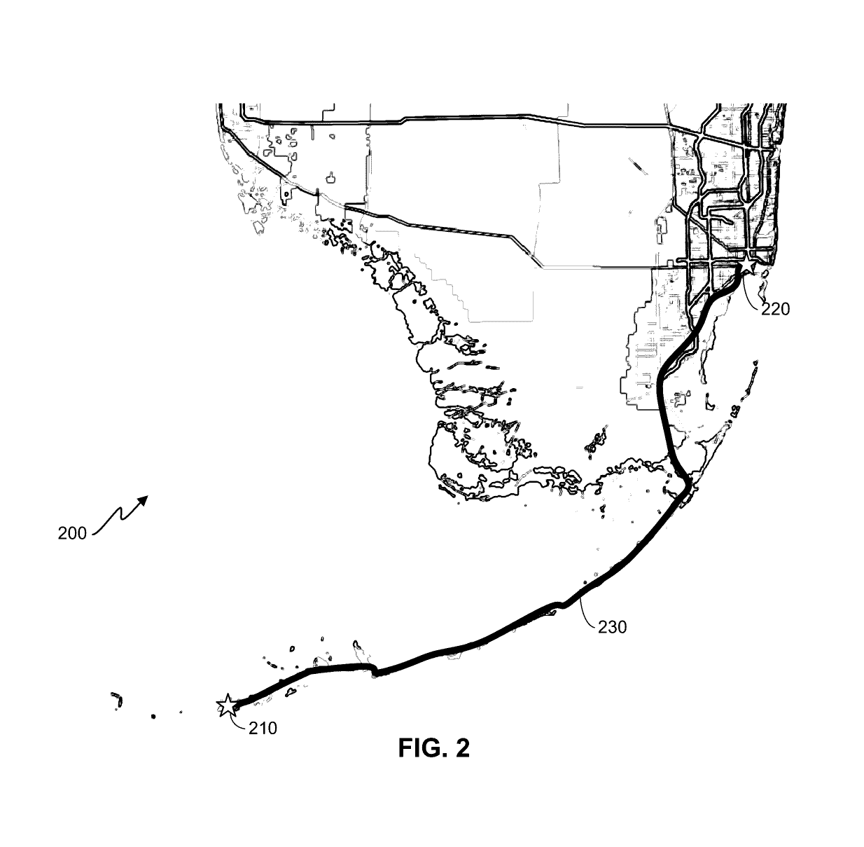

By using the information regarding a route of travel along with the coverage information, the cells covering the route of travel can be identified, and scanning of the mobile device can streamlined to search for the identified cells. FIGS. 2-4 help illustrate this process of identification.

FIG. 2 is an example illustration of a map 200, used to help visualize a route of travel 230 from a point of origin 220 to a destination 210. In this example, the route of travel 230 is in Florida, where the point of origin 220 is Miami and the destination is Key West. An application executed on a mobile device (e.g., the mobile device 105 of FIG. 1) may determine the route of travel 230 based on user input, and may use Internet resources (e.g., remote servers) to do so.

Depending on desired functionality, the features of the application may vary. In some embodiments, the application can provide a user interface in which the map 200 and route of travel 230 are shown. In some embodiments, the current location of the mobile device may also be shown to the user on the map 200 and/or provide navigation instructions as the mobile device travels along the route of travel 230. In some embodiments, the application may not show a map or provide navigation instructions. Embodiments may utilize existing map applications, such as Google Maps for Android® and/or Maps for iPhone®. In some embodiments, the application can then provide the route of travel to another application or function executed by the mobile device. In some embodiments, for example, the application may provide the route of travel to a modem (communications interface) of the mobile device, which can execute code for performing the techniques discussed below.

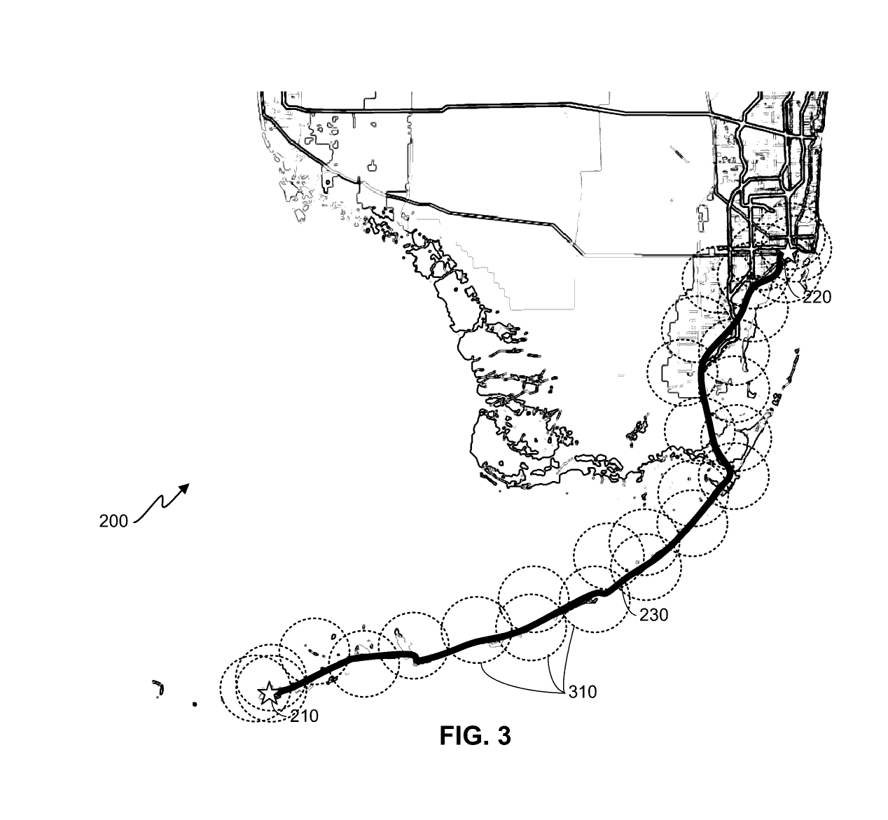

FIG. 3 illustrates how relevant cells 310 can then be identified, based on the route of travel 230. Coverage area for all cells in a region—not just the relevant cells 310 along a route of travel 230—can be obtained and stored on a server as discussed above. Furthermore, some embodiments may enable this information to be provided to the mobile device. By knowing the route of travel, and the coverage area for all cells in a region, the relevant cells 310 can be identified (e.g., by the mobile device and/or the server, depending on the embodiment) as having coverage areas through or near which the route of travel 230 passes. The rest of the cells (not shown) can be ignored.

In FIG. 3 the coverage areas for relevant cells 310 are represented by dotted circles, although it will be understood that the size and shape of the relevant cells 310 may vary. (As indicated above, cells may have pie-shaped coverage areas.) For simplicity, only a few relevant cells 310 in FIG. 3 have been labeled. A person of ordinary skill in the art will recognize that the location and distribution of relevant cells can vary, depending on the WWAN provider, the route of travel, and other factors.

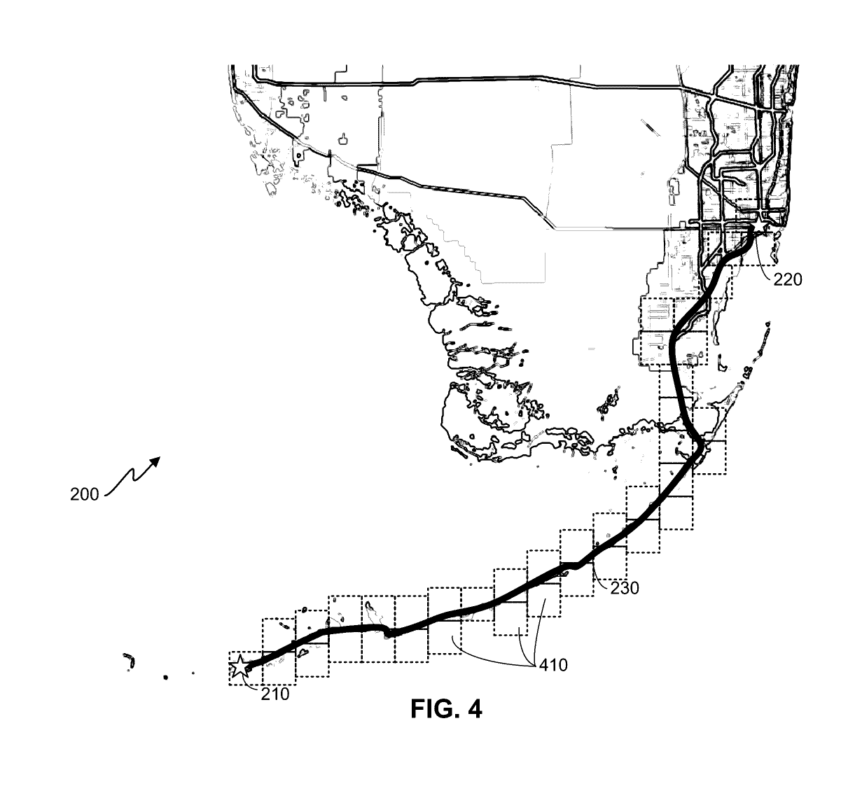

With the relevant cells 310 identified, the mobile device can modify its scanning to increase efficiency. For example, rather than conduct a scan in which many, perhaps hundreds, of cells are detected, the mobile device can stop its scan once it has determined that it has detected the relevant cells 310 for a particular location along the route of travel 230. In some embodiments, the relevant cells 310 may be provided in an order as the mobile device travels along the route of travel 230 from the point of origin 220 to the destination 210. One way in which the information regarding relevant cells 310 may be provided is through the use of “tiles,” as depicted in FIG. 4.

FIG. 4 illustrates the map 200 of FIGS. 2 and 3. Here, however, various tiles 410 are illustrated along the route of travel 230. (Again, for simplicity, only a few tiles 410 are labeled.) Each tile 410 represents a geographical area on or near the route of travel 230. Each tile 410 can further be associated with one or more relevant cells 310 with geographical coverage areas that overlap with the tile and provided to a mobile device, enabling the mobile device to modify its scanning accordingly.

In some embodiments, for example, a server may use the route of travel 230 provided by a mobile device to identify the relevant cells 310. The server can then create tiles with associated cells to allow the mobile device to know, upon entering each tile 410 along the route of travel 230, which cell(s) to look for in scanning.

Table 1 below provides a generic example of how tile information may be provided to the mobile device.

TABLE 1

| Tile | Associated Cell(s) |
|---|---|
| Tile 1 | Cell a, Cell b, Cell c |
| Tile 2 | Cell b, Cell c, Cell d, Cell e, Cell f |
| . | . |
| . | . |
| . | . |
| Tile N | Cell y, Cell z |

As shown, each tile has one or more relevant cells with which it is associated. The number of cells can vary, depending on the actual number of cells in the tile, the amount of memory and/or bandwidth of the mobile device, and/or other factors. In some embodiments, up to 24 cells can be provided for each tile. Other embodiments may allow a larger or smaller number of cells to be associated with each tile.

Depending on desired functionality, the tile (e.g., Tile 1, Tile 2, etc. of Table 1) may further include coordinates and/or other descriptors that define the geographical area of the tile. Moreover, in contrast to the tiles 410 shown in FIG. 4, tiles can be different shapes and sizes, and may overlap. In some embodiments, tiles may form a grid. In some embodiments, the tiles may be predetermined and selected once the route of travel 230 is determined In other embodiments, the tiles may be created, or defined, on the fly, after the route of travel 230 is received.

Some embodiments may allow a mobile device to learn over time the cells it has observed from its own experience. The mobile device may then build up its own version of a tile, which it may use in addition or as an alternative to a tile received from a server.

Depending on desired functionality, embodiments may enable the mobile device to download information for all tiles associated with the route of travel 230 at once, or in smaller subsets. In the former case, if a new route is determined subsequently to the download (e.g., if a user takes a detour), a new set of tiles associated with the new route can be downloaded. In the latter case, the mobile device may download information regarding one or a few tiles as the mobile device approaches or enters the tile(s) when moving along the route of travel. To save memory space on the mobile device, information regarding old tiles may be purged as information regarding new tiles is downloaded.

The size of the tiles may further depend on movement of the device. For instance, if the mobile device is moving slowly (e.g., at a walking speed), this information may be passed along to the server when the mobile device is requesting to download the next tile along the route of travel 230. The server can then use this device to provide a relatively small tile. On the other hand, if the mobile device is moving quickly (e.g., at a driving speed), the server can then use this device to provide a relatively large tile. In one example, when the mobile device is moving at relatively slower speeds, tiles may extend 200 m to either side of a highway along with the route of travel passes. At higher speeds, this distance may extend to 500 m or 1 km. This functionality can help ensure that the memory of the mobile device is used efficiently when moving at relatively slower speeds, while also ensuring that, at relatively faster speeds, the mobile device has sufficient time in the tile before requesting and downloading information regarding the next tile. The speed of a mobile device may be determined using a GPS receiver and/or other sensors (e.g., accelerometer, gyroscope, etc.) of the mobile device.

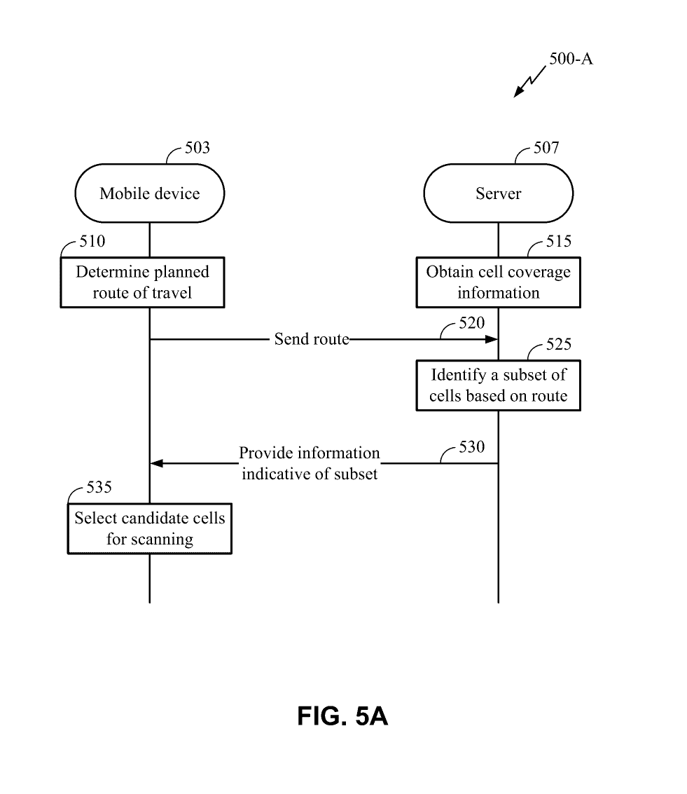

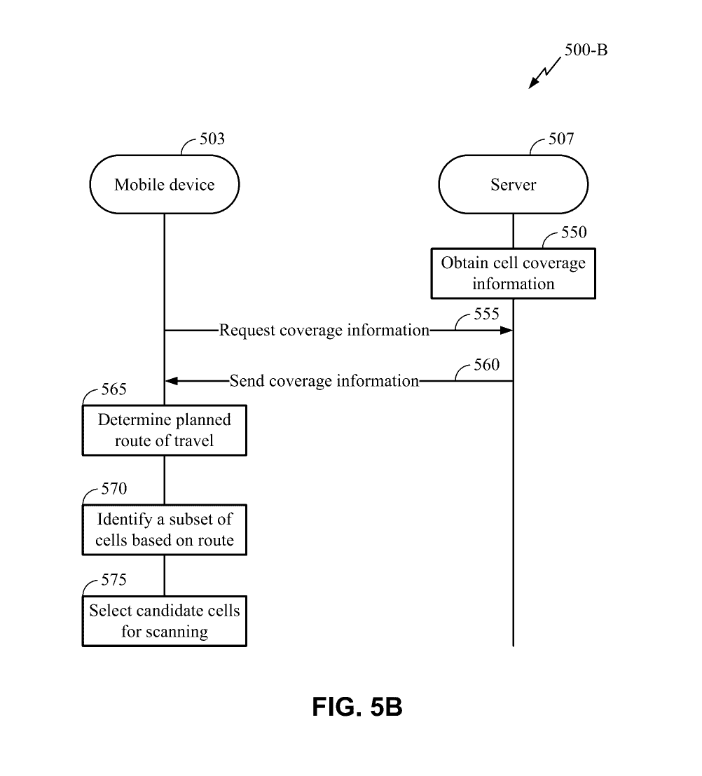

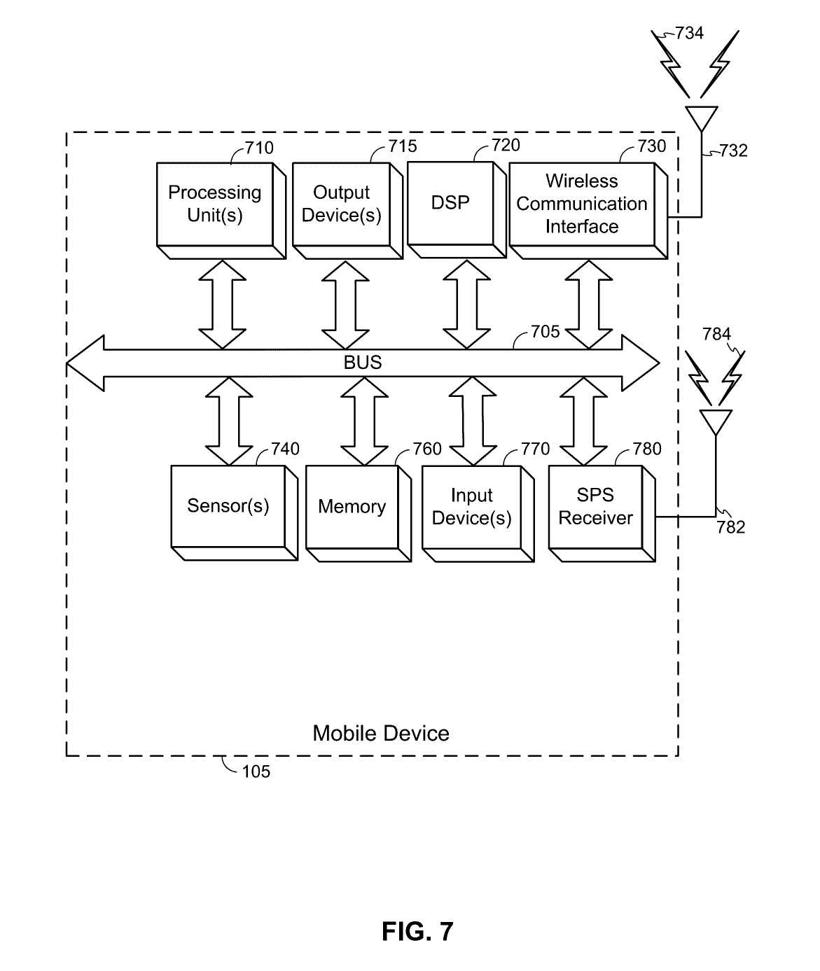

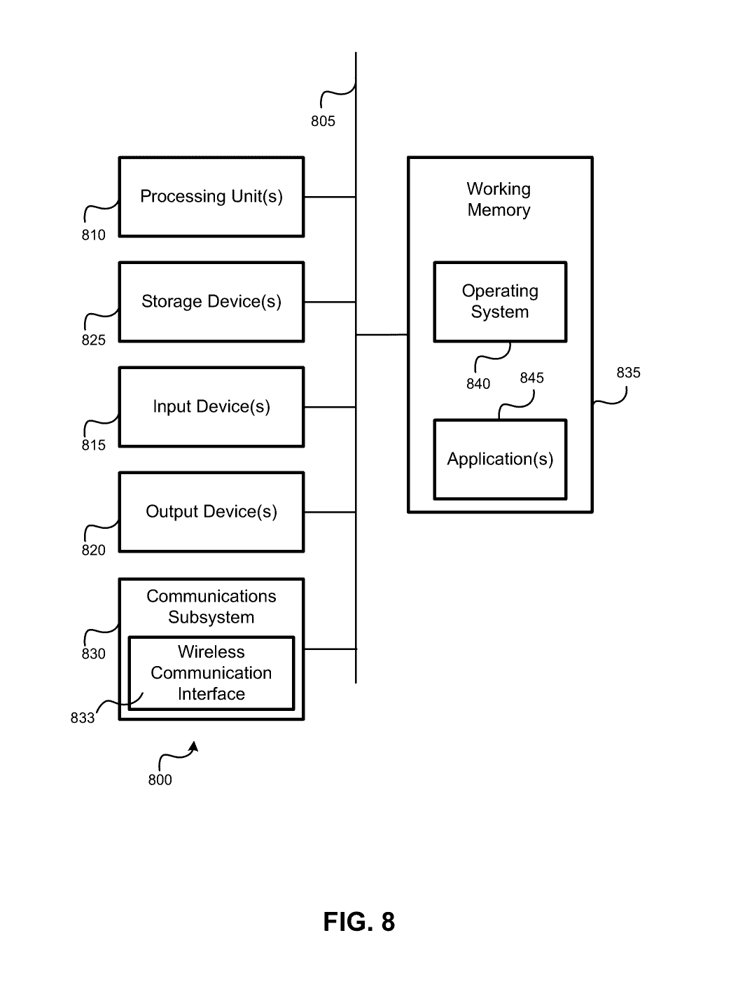

FIGS. 5A and 5B are call flow diagrams that help illustrate the interaction between a mobile device 503 and a server 507, according to two different embodiments. Here, the mobile device 503 may correspond to the mobile device 105 of FIG. 1, and the server 507 may correspond to the location server(s) 160 of FIG. 1. As with other figures provided herein, FIGS. 5A and 5B are provided as non-limiting examples. Alternative embodiments may include additional functionality to that shown in the figures, and/or the functionality shown in one or more of the aspects in the figures may be omitted, combined, separated, and/or performed simultaneously. Means for performing the functionality of the mobile device 503 may include hardware and/or software components of a mobile device, such as the mobile device depicted in FIG. 7. Means for performing the functionality of the server 507 may include hardware and/or software components of a computing device, such as the computer depicted in FIG. 8. A person of ordinary skill in the art will recognize many variations.

The process 500-A shown in FIG. 5A illustrates an embodiment in which the server 507 is provided the route of travel. The process 500-A can begin at block 510, where the mobile device determines a planned route of travel. As discussed previously, this determination may be made using a map or navigational application executed by the mobile device. The application may then provide the determined route of travel to a different application or process of the mobile device (such as code executed by the mobile device's communication interface), which can be in communication with the server 507.

At 520, the route is sent from the mobile device to the server. The route may be sent in any of a variety of formats, including the format in which the route was determined by the application. In some embodiments, the route may comprise a list of locations (e.g., absolute coordinates) along the planned route of travel. This list may be in sequential order from the point of origin to the destination.

At block 515, which may occur prior to blocks 520 and/or 510, the server obtains cell coverage information. As explained above, this information may be obtained from a carrier, via crowdsourcing, and/or other means. The cell coverage information can include information regarding the coverage area for each cell in a region. In the example depicted in FIGS. 2-4, for instance, the cell coverage information may include information regarding the coverage area for each cell in the entire southern portion of Florida as shown on the map 200. In some embodiments, cell coverage information for all cells in a larger region, or even worldwide, may be kept on the server 507.

At block 525, the server 507 uses the cell coverage information and the route information to identify a subset of cells based on the route. Here, the subset of cells may include the relevant cells along the route, as shown in FIG. 3. Depending on desired functionality, the subset of cells may further include cells that have coverage regions within a threshold distance of the route.

At 530, information indicative of the subset of cells is sent by the server 507 to the mobile device 503. As indicated above, some embodiments may provide this information as a plurality of tiles, which may be downloaded all at once or sequentially by the mobile device 503, depending on desired functionality.

At block 535, the mobile device 503 selects candidate cells for scanning based on the information indicative of the subset of cells provided by the server 507. In some embodiments, for example, candidate cells may be selected based on tiles or other information provided by the server. Once candidate cells are selected, scanning can be modified and/or optimized, reducing the time and power used for scanning In some embodiments, scanning may be modified such that a scan is stopped once candidate cells are detected.

The process 500-B shown in FIG. 5B illustrates an embodiment in which the server 507 is not provided the route of travel. Similar to block 515 in process 500-A of FIG. 5A, the server 507 obtains cell coverage information at block 550. However, at 555 the mobile device 503 then requests the coverage information from the server 507, which sends to coverage information to the mobile device 503 at 560.

With this information, the mobile device 503 can perform the remaining functions without further interaction with the server 507. At block 565, the mobile device 503 determines a planned route of travel, in a manner similar to block 510 in process 500-A of FIG. 5A. Unlike process 500-A of FIG. 5A, however, at block 570 it is the mobile device 503, rather than the server 507, that identifies a subset of cells based on the planned route of travel. At block 575, the mobile device 503 selects candidate cells in a manner similar to block 535 in process 500-A of FIG. 5A.

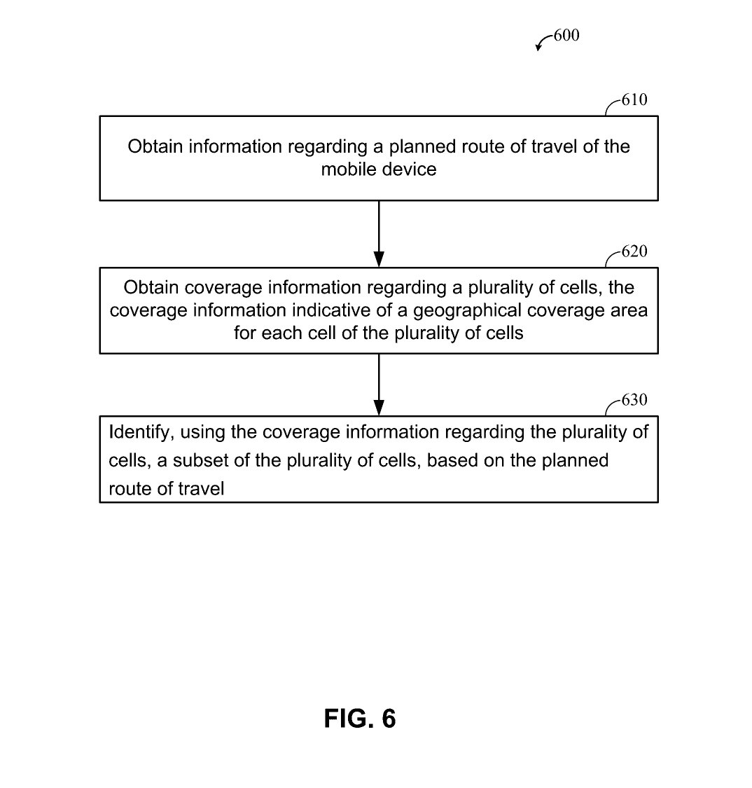

FIG. 6 is a flow diagram 600 illustrating a method for enabling predictive data assistance at a mobile device, according to one embodiment. Again, alternative embodiments may include additional functionality to that shown in the figure, and/or the functionality shown in one or more of the blocks in the figure may be omitted, combined, separated, and/or performed simultaneously. The functionality illustrated in the flow diagram 600 may be performed by a mobile device and/or a server, as demonstrated in FIGS. 5A and 5B. Thus, means for performing the functionality of various blocks in the flow diagram 600 may include hardware and/or software components of a mobile device, such as the mobile device depicted in FIG. 7 and/or a computing device, such as the computer depicted in FIG. 8. A person of ordinary skill in the art will recognize many variations.

At block 610, information is obtained from an application executed by the mobile device regarding a planned route of travel of the mobile device. In some embodiments, this information may be obtained by a separate application or function executed by the mobile device, such a code executed by the mobile device's communication interface. In some embodiments, this information may be obtained by a server remote from the mobile device. As such, means for performing the functions of block 610 may include, for example, the processing unit(s) 710, DSP 720, wireless communication interface 730, input device(s) 770, memory 760, and/or SPS receiver 780 of the mobile device 105 of FIG. 7, and/or the communications subsystem 830, wireless communication interface 833, processing unit(s) 810, and/or working memory 835 of the computer system 800 of FIG. 8.

At block 620, coverage information regarding a plurality of cells is obtained, where the coverage information is indicative of a geographical coverage area for each cell of the plurality of cells. This coverage information can, for example, enable a server and/or a mobile device to identify which cells can provide coverage along the planned route of travel, as illustrated and described in relation to FIG. 3. For embodiments in which obtaining coverage information regarding the plurality of cells is performed by a server, this information can be obtained via a WWAN provider, mobile device crowdsourcing and/or other sources, as discussed above. For embodiments in which obtaining coverage information regarding the plurality of cells is performed by the mobile device, such obtaining may comprise receiving, with the mobile device, the information regarding the plurality of cells from a server. Again, this information may be obtained by a server remote from the mobile device and/or by the mobile device itself (e.g., via download from the server, as shown in FIG. 5B). As such, means for performing the functions of block 620 may include, for example, the processing unit(s) 710, DSP 720, wireless communication interface 730, input device(s) 770, and/or memory 760 of the mobile device 105 of FIG. 7, and/or the communications subsystem 830, wireless communication interface 833, processing unit(s) 810, storage device(s) 825, and/or working memory 835 of the computer system 800 of FIG. 8.

At block 630, a subset of the plurality of cells is identified using the coverage information regarding the plurality of cells (obtained at block 620), where the identification is based on the planned route of travel. As discussed previously, the coverage information can be used to identify which cells have coverage on or near (within a threshold distance) of the planned route of travel, reducing the plurality of cells to a subset of identified cells that are relevant to the planned route of travel (as shown in FIG. 3). As indicated in FIGS. 5A and 5B, this identification can be performed by a mobile device or a server, depending on desired functionality. As such, means for performing the functions of block 630 may include, for example, the processing unit(s) 710, DSP 720, and/or memory 760 of the mobile device 105 of FIG. 7, and/or the processing unit(s) 810, storage device(s) 825, and/or working memory 835 of the computer system 800 of FIG. 8.

Embodiments may include additional functionality, depending on desired functionality. For example, for embodiments in which identification of the subset (block 630) is performed by a server, the server may further send the information indicative of the identified subset to the mobile device. Additionally or alternatively, as discussed above, the information indicative of the identified subset can include information indicative of a plurality of tiles representing geographical areas along the planned route of travel, and for each tile of the plurality of tiles, one or more cells corresponding to the tile. Embodiments may further include defining, subsequent to obtaining the information regarding a planned route of travel, one or more tiles of the plurality of tiles in an on-the-fly manner as discussed above.

For embodiments in which identification of the subset (block 630) is performed by the mobile device, this information may be provided to an application or function executed by the mobile device that executes and/or otherwise controls the mobile device's process for scanning for candidate cells. As such, server-side and mobile-side means for performing these functions may include, for example, the processing unit(s) 710, DSP 720, wireless communication interface 730, input device(s) 770, and/or memory 760 of the mobile device 105 of FIG. 7, and/or the communications subsystem 830, wireless communication interface 833, processing unit(s) 810, storage device(s) 825, and/or working memory 835 of the computer system 800 of FIG. 8.

Some embodiments may further comprise selecting candidate cells for scanning based on the identified subset of the plurality of cells. As indicated elsewhere herein, by having predictive data that includes identified cells the mobile device will encounter along the planned route of travel, the scanning process can be streamlined to stop once one or more signals from each of the candidate cells has been detected by the mobile device, rather than continuing to scan for additional cells. In some embodiments, candidate cells may include the entire subset of the plurality of cells. In some embodiments, candidate cells may include only a portion of the plurality of cells. The portion may be dependent on a location of the mobile device. As such, selecting candidate cells may involve determining candidate cells using a tile for a particular location (as shown in FIG. 4). Means for performing the functionality of block 650 may include, for example, the processing unit(s) 710, DSP 720, wireless communication interface 730, input device(s) 770, and/or memory 760 of the mobile device 105 of FIG. 7.

FIG. 7 illustrates an embodiment of a mobile device 105, which can be utilized as described herein above. For example, the mobile device 105 can be used as shown in the telecommunication system 100 of FIG. 1, and/or to perform functions as described in relation to FIGS. 5A, 5B, and 6. It should be noted that FIG. 7 is meant only to provide a generalized illustration of various components, any or all of which may be utilized as appropriate. It can be noted that, in some instances, components illustrated by FIG. 7 can be localized to a single physical device and/or distributed among various networked devices, which may be disposed at different physical locations.

The mobile device 105 is shown comprising hardware elements that can be electrically coupled via a bus 705 (or may otherwise be in communication, as appropriate). The hardware elements may include a processing unit(s) 710 which may comprise without limitation one or more general-purpose processors, one or more special-purpose processors (such as digital signal processing (DSP) chips, graphics acceleration processors, application specific integrated circuits (ASICs), and/or the like), and/or other processing structure or means, which can be configured to perform one or more of the methods described herein. As shown in FIG. 7, some embodiments may have a separate DSP 720, depending on desired functionality. The mobile device 105 also may comprise one or more input devices 770, which may comprise without limitation a touch screen, a touch pad, microphone, button(s), dial(s), switch(es), and/or the like; and one or more output devices 715, which may comprise without limitation a display, light emitting diode (LED), speakers, and/or the like. According to some embodiments, the input devices 770 can be used to receive user input regarding desired destination, with which a route of travel may be determined

The mobile device 105 might also include a wireless communication interface 730, which may comprise without limitation a modem, a network card, an infrared communication device, a wireless communication device, and/or a chipset (such as a Bluetooth™ device, an IEEE 802.11 device, an IEEE 802.15.4 device, a WiFi device, a WiMax device, cellular communication facilities, etc.), and/or the like. The wireless communication interface 730 may permit data (such as determined route of travel) to be communicated with a network, server, other computer systems, and/or any other electronic devices described herein. The communication can be carried out via one or more wireless communication antenna(s) 732 that send and/or receive wireless signals 734.

Depending on desired functionality, the wireless communication interface 730 may comprise separate transceivers to communicate with base transceiver stations (e.g., antenna 120) and other wireless devices and access points. Different data networks may comprise various network types. Additionally, a WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMax (IEEE 802.16), and so on. A CDMA network may implement one or more radio access technologies (RATs) such as cdma2000, Wideband-CDMA (W-CDMA), and so on. Cdma2000 includes IS-95, IS-2000, and/or IS-856 standards. A TDMA network may implement Global System for Mobile Communications (GSM), Digital Advanced Mobile Phone System (D-AMPS), or some other RAT. An OFDMA network may employ LTE, LTE Advanced, and so on. LTE, LTE Advanced, GSM, and W-CDMA are described in documents from 3GPP. Cdma2000 is described in documents from a consortium named “3rd Generation Partnership Project 2” (3GPP2). 3GPP and 3GPP2 documents are publicly available. A WLAN may also be an IEEE 802.11x network, and a WPAN may be a Bluetooth network, an IEEE 802.15x, or some other type of network. The techniques described herein may also be used for any combination of WWAN, WLAN and/or WPAN.

The mobile device 105 can further include sensor(s) 740. Such sensors may comprise, without limitation, one or more accelerometer(s), gyroscope(s), camera(s), magnetometer(s), altimeter(s), microphone(s), proximity sensor(s), light sensor(s), and the like. Some or all of the sensor(s) 740 can be utilized, among other things, for dead reckoning and/or other positioning methods. Such positioning methods may be used to determine a location of the mobile device 105. Additionally or alternatively, some or all of the sensor(s) 740 can be utilized, among other things, speed and/or motion determination, as described herein.

Embodiments of the mobile device may also include an SPS receiver 780 capable of receiving signals 784 from one or more SPS satellites (such as SPS satellites 110, of FIG. 1) using an SPS antenna 782. Such positioning can be utilized to complement and/or incorporate the techniques described herein. The SPS receiver 780 can extract a position of the mobile device, using conventional techniques, from SPS SVs of an SPS system, such as GNSS (e.g., Global Positioning System (GPS)), Galileo, Glonass, Compass, Quasi-Zenith Satellite System (QZSS) over Japan, Indian Regional Navigational Satellite System (IRNSS) over India, Beidou over China, and/or the like. Moreover, the SPS receiver 780 can be used various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi -functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

The mobile device 105 may further include and/or be in communication with a memory 760. The memory 760 may comprise, without limitation, local and/or network accessible storage, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The memory 760 of the mobile device 105 also can comprise software elements (not shown), including an operating system, device drivers, executable libraries, and/or other code, such as one or more application programs (as described herein), which may comprise computer programs provided by various embodiments, and/or may be designed to implement methods, and/or configure systems, provided by other embodiments, as described herein. Merely by way of example, one or more procedures described with respect to the functionality discussed above might be implemented as code and/or instructions executable by the mobile device 105 (and/or a processing unit within a mobile device 105) (and/or another device of a positioning system). In an aspect, then, such code and/or instructions can be used to configure and/or adapt a general purpose computer (or other device) to perform one or more operations in accordance with the described methods.

FIG. 8 illustrates an embodiment of a computer system 800, which may be incorporated, at least in part, into devices such as the location server(s) 160 of FIG. 1, and/or to perform functions as described in relation to FIGS. 5A, 5B, and 6 relating to a server. It should be noted that FIG. 8 is meant only to provide a generalized illustration of various components, any or all of which may be utilized as appropriate. FIG. 8, therefore, broadly illustrates how individual system elements may be implemented in a relatively separated or relatively more integrated manner. In addition, it can be noted that components illustrated by FIG. 8 can be localized to a single device (e.g., a single server) and/or distributed among various networked devices, which may be disposed at different physical locations.

The computer system 800 is shown comprising hardware elements that can be electrically coupled via a bus 805 (or may otherwise be in communication, as appropriate). The hardware elements may include processing unit(s) 810, which may comprise without limitation one or more general-purpose processors, one or more special-purpose processors (such as digital signal processing chips, graphics acceleration processors, and/or the like), and/or other processing structure, which can be configured to perform one or more of the methods described herein, including the methods described in relation to FIGS. 5A, 5B, and 6. The computer system 800 also may comprise one or more input devices 815, which may comprise without limitation a mouse, a keyboard, a camera, a microphone, and/or the like; and one or more output devices 820, which may comprise without limitation a display device, a printer, and/or the like.

The computer system 800 may further include (and/or be in communication with) one or more non-transitory storage devices 825, which can comprise, without limitation, local and/or network accessible storage, and/or may comprise, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 800 might also include a communications subsystem 830, which may comprise wireless communication technologies managed and controlled by a wireless communication interface 833, as well as wired technologies. As such, the communications subsystem may comprise a modem, a network card (wireless or wired), an infrared communication device, a wireless communication device, and/or a chipset (such as a BluetoothTM device, an IEEE 802.11 device, an IEEE 802.15.4 device, a WiFi device, a WiMax device, cellular communication facilities, UWB interface, etc.), and/or the like. The communications subsystem 830 may include one or more input and/or output communication interfaces, such as the wireless communication interface 833, to permit data to be exchanged with a network, mobile devices (such as the mobile device 105 of FIG. 1), other computer systems, and/or any other electronic devices described herein. Hence, the communications subsystem 830 may be used to receive and send data as described in the embodiments herein.

In many embodiments, the computer system 800 will further comprise a working memory 835, which may comprise a RAM or ROM device, as described above. Software elements, shown as being located within the working memory 835, may comprise an operating system 840, device drivers, executable libraries, and/or other code, such as one or more application programs 845, which may comprise computer programs provided by various embodiments, and/or may be designed to implement methods, and/or configure systems, provided by other embodiments, as described herein. Merely by way of example, one or more procedures described with respect to the method(s) discussed above, such as the methods described in relation to FIGS. 5A, 5B, and 6, might be implemented as code and/or instructions executable by a computer (and/or a processing unit within a computer); in an aspect, then, such code and/or instructions can be used to configure and/or adapt a general purpose computer (or other device) to perform one or more operations in accordance with the described methods. For example, the computer system 800 and software elements can be used to build and maintain a database and/or other data structure that has the cell coverage information described in embodiments disclosed herein.

A set of these instructions and/or code might be stored on a non-transitory computer-readable storage medium, such as the storage device(s) 825 described above. In some cases, the storage medium might be incorporated within a computer system, such as computer system 800. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 800 and/or might take the form of source and/or installable code, which, upon compilation and/or installation on the computer system 800 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As previously indicated, although embodiments described herein (and shown in FIG. 3) illustrate a cell as covering a circular area, it is common that an antenna (or antenna array) covers a circular area split three ways circumferentially among three cells (each cell spanning approximately 120 degrees of the circular area). Additionally, it will be understood that embodiments in which the Internet is used may additionally or alternatively use one or more other public and/or private data networks.

With reference to the appended figures, components that may comprise memory may comprise non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one ” of if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the spirit of the disclosure. For example, the above elements may merely be a component of a larger system, wherein other rules may take precedence over or otherwise modify the application of the aspects and implementations. Also, a number of steps may be undertaken before, during, or after the above elements are considered. Accordingly, the above description does not limit the scope of the disclosure.

What is claimed is:

1. A method for optimizing cell scanning at a mobile device, the method comprising:
obtaining information regarding a planned route of travel of the mobile device;
obtaining coverage information regarding a plurality of cells, the coverage information indicative of a geographical coverage area for each cell of the plurality of cells; and
identifying, using the coverage information regarding the plurality of cells, a subset of the plurality of cells, based on the planned route of travel.

2. The method of claim 1 wherein obtaining the information regarding the planned route of travel, obtaining the coverage information regarding the plurality of cells, and identifying the subset of the plurality of cells are performed, at least in part, by a server, wherein the method further comprises sending, from the server, the information indicative of the identified subset to the mobile device.

3. The method of claim 2 wherein the information indicative of the identified subset comprises information indicative of:
a plurality of tiles representing geographical areas along the planned route of travel, and
for each tile of the plurality of tiles, one or more cells corresponding to the tile.

4. The method of claim 3 further comprising defining, subsequent to obtaining the information regarding the planned route of travel, one or more tiles of the plurality of tiles.

5. The method of claim 4 further comprising determining a speed of the mobile device, wherein a size of at least one tile of the plurality of tiles is based on the determined speed of the mobile device.

6. The method of claim 1 wherein identifying the subset of the plurality of cells is performed by the mobile device, and wherein obtaining coverage information regarding the plurality of cells comprises receiving, with the mobile device, the information regarding the plurality of cells from a server.

7. The method of claim 6 further comprising selecting candidate cells for scanning based on the identified subset of the plurality of cells.

8. The method of claim 7 further comprising ending a scan after one or more signals from each of the candidate cells has been detected by the mobile device.

9. A mobile device comprising:
a memory;
a communication interface; and
a processing unit communicatively coupled to the memory and the communication interface and configured to cause the mobile device to:
obtain information regarding a planned route of travel of the mobile device;
obtain coverage information regarding a plurality of cells, the coverage information indicative of a geographical coverage area for each cell of the plurality of cells;
identify, using the coverage information regarding the plurality of cells, a subset of the plurality of cells, based on the planned route of travel

10. The mobile device of claim 9, wherein the processing unit is configured to cause the mobile device to obtain the coverage information regarding the plurality of cells by obtaining information indicative of a plurality of tiles representing geographical areas along the planned route of travel, wherein for each tile of the plurality of tiles, one or more cells corresponds to the tile.

11. The mobile device of claim 9, wherein the processing unit is configured to cause the mobile device to obtain the coverage information regarding the plurality of cells by:
sending the information regarding the planned route of travel of the mobile device to a server; and
receiving the coverage information regarding the plurality of cells from the server.

12. The mobile device of claim 9, wherein the processing unit is further configured to cause the mobile device to select candidate cells for scanning based on the identified subset of the plurality of cells.

13. An apparatus comprising:
means for obtaining information regarding a planned route of travel of a mobile device;
means for obtaining coverage information regarding a plurality of cells, the coverage information indicative of a geographical coverage area for each cell of the plurality of cells; and
means for identifying, using the coverage information regarding the plurality of cells, a subset of the plurality of cells, based on the planned route of travel.

14. The apparatus of claim 13 wherein the apparatus comprises a server further comprising means for sending, from the server, the information indicative of the identified subset to the mobile device.

15. The apparatus of claim 14 wherein the means for sending the information indicative of the identified subset comprises means for providing information indicative of:
a plurality of tiles representing geographical areas along the planned route of travel, and
for each tile of the plurality of tiles, one or more cells corresponding to the tile.

16. The apparatus of claim 15 further comprising means for defining, subsequent to obtaining the information regarding the planned route of travel, one or more tiles of the plurality of tiles.

17. The apparatus of claim 16 further comprising means for determining a speed of the mobile device, wherein a size of at least one tile of the plurality of tiles is based on the determined speed of the mobile device.

18. The apparatus of claim 13 wherein the apparatus comprises the mobile device, and wherein the means for obtaining coverage information regarding the plurality of cells comprises means for receiving, with the mobile device, the information regarding the plurality of cells from a server.

19. The apparatus of claim 18 further comprising means for selecting candidate cells for scanning based on the identified subset of the plurality of cells.

20. The apparatus of claim 19 further comprising means for ending a scan after one or more signals from each of the candidate cells has been detected by the mobile device.
